(19) United States
(12) Patent Application Publication
(10) Pub. No.: US 2014/0057364 A1
(43) Pub. Date: Feb. 27, 2014

(54) METHOD OF DIAGNOSING ALZHEIMERS DISEASE USING SALIVA

(71) Applicant: Electronics and Telecommunications Research Institute, (US)

(72) Inventors: Chang-Beom KIM, Seoul (KR); Kibong SONG, Daejeon (KR); Kwan Su KIM, Seoul (KR)

(73) Assignee: Electronics and Telecommunications Research Institute, Daejeon (KR)

(21) Appl. No.: 13/801,925

(22) Filed: Mar. 13, 2013

(30) Foreign Application Priority Data
Aug. 24, 2012 (KR) 10-2012-0092787

(51) Int. Cl. G01N 21/64

(52) U.S. Cl. CPC G01N 21/6486
USPC 436/501

(57) ABSTRACT

Provided is a method of diagnosing Alzheimer's disease. The method of diagnosing Alzheimer's disease includes preparing magnetic particles having primary capture antibodies specifically bonded with beta-amyloid adsorbed thereon, introducing saliva containing beta-amyloid into the magnetic particles to bond the beta-amyloid contained in the saliva with the primary capture antibodies, bonding secondary capture antibodies labeled with fluorescent substances to the magnetic particles bonded with the beta-amyloid to form a complex, disposing the complex in a channel region of an photoelectric conversion device in which photoelectric current is changed according to an amount of incident light, and measuring photoelectric current changed by light excited from the complex to quantify a concentration of the beta-amyloid contained in the saliva.

### CROSS-REFERENCE TO RELATED APPLICATIONS

This U.S. non-provisional patent application claims priority under 35 U.S.C. §119 of Korean Patent Application No. 10-2012-0092787, filed on Aug. 24, 2012, the entire contents of which are hereby incorporated by reference.

### BACKGROUND

The present invention disclosed herein relates to a method of diagnosing Alzheimer's disease, and more particularly, to a method of diagnosing Alzheimer's disease using saliva.

As the most common form of dementia, a senile neurodegenerative disease, Alzheimer's disease has emerged as a socioeconomic and medical issue while the social structure changes into an aging society in line with a recent worldwide increase in average life span. Current medical techniques may not treat Alzheimer's disease or stop pathological progression thereof, but fortunately, a decrease in progression rate may be possible, and thus, most treatments are focused on this. Research has been conducted to date in various fields, such as biology, biochemistry, anthroposophy, and ethology, after the discovery of the disease in the early 1990s, and the importance of the early diagnosis of Alzheimer's disease has recently begun to emerge. Coping with Alzheimer's disease by early diagnosis may reduce mental and economical burdens in socioeconomic as well as personal view and is the best method of improving quality of life.

A typical diagnosis of Alzheimer's disease consumes a lot of time or depends on complex evaluation by various methods, such as clinical evaluation and psychological tests, brain imaging, and distinction from other neurodegenerative diseases. In consideration of the foregoing points, detection of molecular level biomarkers able to confirm Alzheimer's disease, discern a degree of pathological intensification in patients or predict progression rate, and monitor the state of progression may be most useful. Such molecular level biomarkers must well contain basic neuropathological features and have sensitivity and specificity comparable to a clinical diagnosis level. Also, the molecular level biomarkers must have reliability and reproducibility, and it may be ideal if low cost, non-invasiveness, and ease are companied during the extraction of samples inherent to biomarkers. Typical samples related to Alzheimer's disease may include skin tissue, rectal tissue, marrow, or spinal fluid, and sampling thereof may not be suitable for regular clinical diagnosis.

For example, a typical method of diagnosing Alzheimer's disease may include a brain imaging technique using a high-resolution brain imaging device. The method of early diagnosing Alzheimer's disease through the brain imaging technique measures a degree of abnormal accumulation of beta-amyloid protein through brain imaging of suspected Alzheimer's disease patients and accuracy of the brain imaging device is studied through comparative analysis with the results of patents' postmortem brain biopsy. However, the image-based diagnostic method may not only require high cost to the patients, but detection of the disease may also be late because diagnosis may be completed in a state in which brain shrinkage or damage is already in progress. Another typical diagnostic method includes diagnosis of spinal fluid in which changes in the amount of beta-amyloid protein in cerebrospinal fluid are measured. However, a cerebrospinal fluid examination method itself is known to be very painful to the patients and risk may be associated during the examination.

### SUMMARY

The present invention provides a method of diagnosing Alzheimer's disease using saliva.

The object of the present invention is not limited to the aforesaid, but other objects not described herein will be clearly understood by those skilled in the art from descriptions below.

Embodiments of the present invention provide methods of diagnosing Alzheimer's disease including: preparing magnetic particles having primary capture antibodies specifically bonded with beta-amyloid adsorbed thereon; introducing saliva containing beta-amyloid into the magnetic particles to bond the beta-amyloid contained in the saliva with the primary capture antibodies; bonding secondary capture antibodies labeled with fluorescent substances to the magnetic particles bonded with the beta-amyloid to form a complex; disposing the complex in a channel region of a photoelectric conversion device in which photoelectric current is changed according to an amount of incident light; and measuring photoelectric current changed by light excited from the complex to quantify a concentration of the beta-amyloid contained in the saliva.

In some embodiments, the photoelectric conversion device may include an optical filter layer only transmitting a wavelength of excitation light excited from the fluorescent substances.

In other embodiments, the optical filter layer may be a selenium (Se) thin film.

In still other embodiments, the photoelectric conversion device may includes a semiconductor substrate, an insulation layer on the semiconductor substrate, a channel pattern on the insulation layer, and .interconnection electrodes disposed on the channel pattern by being spaced apart from each other.

In even other embodiments, the optical filter layer may be disposed on the channel pattern.

In yet other embodiments, the fluorescent substances may be formed of a material emitting light having a wavelength band of 650 nm to 850 nm by excitation light having a wavelength ranging from 400 nm to 550 nm.

In other embodiments of the present invention, methods of diagnosing Alzheimer's disease including: preparing comparison samples having different concentrations of beta-amyloid; preparing magnetic particle samples having beta-amyloid contained in the each comparison sample combined with multiprotein; measuring changes in photoelectric current from the magnetic particle samples by using an optical field effect transistor, in which photoelectric current is changed according to an amount of light, to generate reference data; introducing saliva containing beta-amyloid to prepare magnetic particles having the beta-amyloid contained in the saliva bonded with the multiprotein; measuring changes in photoelectric current from the magnetic particles by using the photoelectric conversion device to generate measurement data; and comparing the reference data and the measurement data to diagnose the presence of Alzheimer's disease.

Particularities of other embodiments are included in the detailed description and drawings.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIGS. 1A and 1B are flowcharts schematically illustrating a method of diagnosing Alzheimer's disease according to an embodiment of the present invention;

FIGS. 2A through 2E are drawings for describing a method of preparing a complex for diagnosing Alzheimer's disease;

FIG. 3 illustrates an photoelectric conversion device for diagnosing Alzheimer's disease according to an embodiment of the present invention;

FIG. 4 illustrates a biomaterial detection device for diagnosing Alzheimer's disease according to an embodiment of the present invention;

FIG. 5 is a graph showing optical characteristic conditions in the photoelectric conversion device for diagnosing Alzheimer's disease according to the embodiment of the present invention;

FIG. 6 is a graph showing photoelectric current characteristics of the photoelectric conversion device for diagnosing Alzheimer's disease according to the embodiment of the present invention; and

FIG. 7 is a graph showing photoelectric current characteristics according to a concentration of beta-amyloid contained in saliva in the method of diagnosing Alzheimer's disease according to the embodiment of the present invention.

### DETAILED DESCRIPTION OF THE EMBODIMENTS

Advantages and features of the present invention, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Further, the present invention is only defined by scopes of claims. In the drawings, like reference numerals refer to like elements throughout.

In the following description, the technical terms are used only for explaining a specific exemplary embodiment while not limiting the present invention. The terms of a singular form may include plural forms unless referred to the contrary. The meaning of “comprises” and/or “comprising” specifies a property, a region, a fixed number, a step, a process, an element and/or a component but does not exclude other properties, regions, fixed numbers, steps, processes, elements and/or components.

Hereinafter, methods of diagnosing Alzheimer's disease using saliva according to embodiments of the present invention will be described with reference to the accompanying drawings.

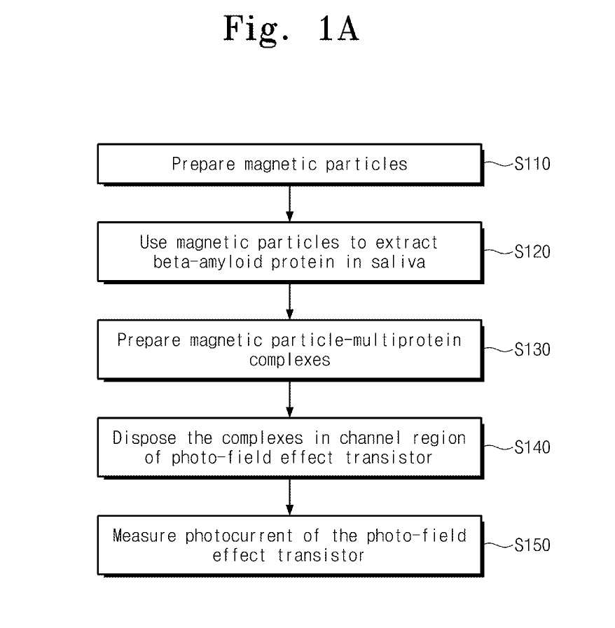

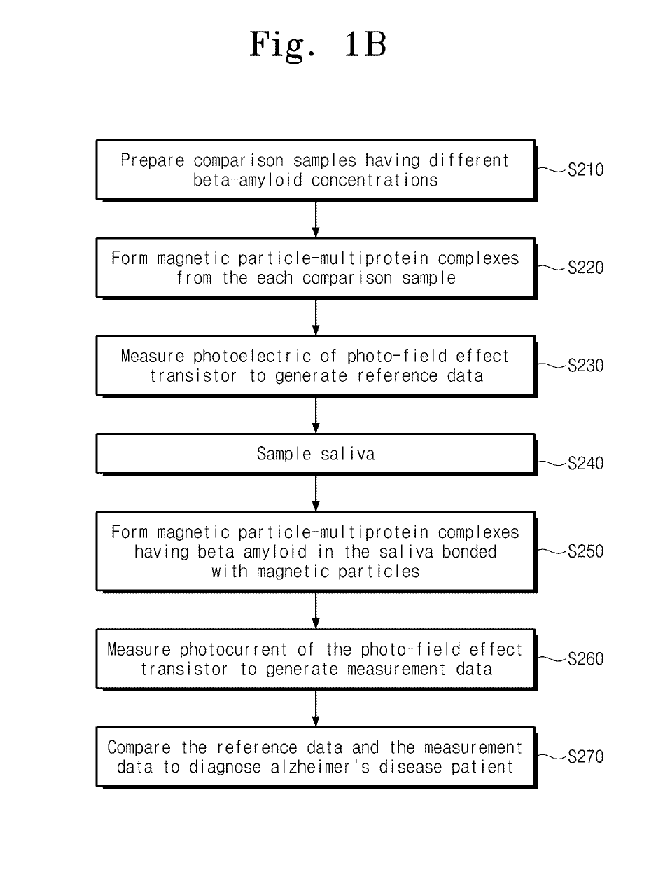

FIGS. 1A and 1B are flowcharts schematically illustrating a method of diagnosing Alzheimer's disease according to an embodiment of the present invention.

Referring to FIG. 1A, magnetic particles for diagnosing Alzheimer's disease are prepared (S110). Primary capture antibodies only selectively bonded with beta-amyloid, Alzheimer's disease-causing protein, among the many proteins contained in saliva may be adsorbed on surfaces of the magnetic particles.

The magnetic particles are used to extract beta-amyloid contained in saliva (S120). The beta-amyloid contained in saliva may be extracted by using an antigen-antibody reaction.

The magnetic particles bonded with beta-amyloid are labeled with fluorescent substances to prepare magnetic particle-multiprotein complexes (S130). The magnetic particles bonded with beta-amyloid may be labeled with fluorescent substances in order to quantify a concentration of beta-amyloid by using a photoelectric conversion device (or a photo-field effect transistor).

The magnetic particle-multiprotein complexes are disposed in a channel region of the photoelectric conversion device (S140). The magnetic particle-multiprotein complexes may be fixed in the channel region of the photoelectric conversion device by using an external magnetic field.

Photoelectric current is measured from the photoelectric conversion device to diagnose Alzheimer's disease and evaluate a degree of intensification thereof (S150). The magnetic particle-multiprotein complexes are irradiated with excitation light and the photoelectric current of the photoelectric conversion device may be changed by emission light emitted from the fluorescent substances. Since an intensity of the emission light may be changed according to an amount of beta-amyloid bonded to the magnetic particles, Alzheimer's disease may be diagnosed and a degree of intensification thereof may be evaluated by measuring changes in photoelectric current.

Thus, reference data, in which the changes in photoelectric current are measured according to the concentration of beta-amyloid, may be prepared in advance, in order to quantify the amount of beta-amyloid contained in saliva, and diagnose Alzheimer's disease and evaluate the degree of intensification thereof

Specifically, referring to FIG. 1B, a plurality of comparison samples having different concentrations of beta-amyloid is prepared (S210) and magnetic particles are introduced into the each comparison sample to form magnetic particle-multiprotein complexes (S220). Changes in photoelectric current are measured from the magnetic particles-multiprotein complex obtained for the each comparison sample by using a photoelectric conversion device to thus generate reference data (S230). For example, a first sample solution (i.e., normal person) having a beta-amyloid concentration ranging from 1 pg/ml to 10 pg/ml is prepared and a magnetic particle-multiprotein complex is formed, and photoelectric current is then measured by using an optical field effect transistor. Thus, fist reference data may be generated. Also, a second sample solution (i.e., Alzheimer's disease patient) having a beta-amyloid concentration ranging from 15 pg/ml to 5,000 pg/ml is prepared and a magnetic particle-multiprotein complex is formed, and photoelectric current is then measured by using the optical field effect transistor. Thus, second reference data may be generated.

Thereafter, saliva of a patient to be diagnosed with Alzheimer's disease is sampled (S240). As illustrated in FIG. 1A, a complex having beta-amyloid contained in the saliva bonded with magnetic particles is formed (S250). Thereafter, photoelectric current changed by the complex of a diagnostic target is measured by using the photoelectric conversion device to thus generate measurement data (S260). Continuously, the presence of Alzheimer's disease may be diagnosed by comparing the measurement data with the first and second reference data (S270).

Also, sample solutions having a concentration ranging from 15 pg/ml to 5,000 pg/ml are variously prepared, the plurality of reference data are generated, and the concentrations of beta-amyloid contained in saliva are quantified and compared, and thus, a degree of intensification of Alzheimer's disease may be segmented.

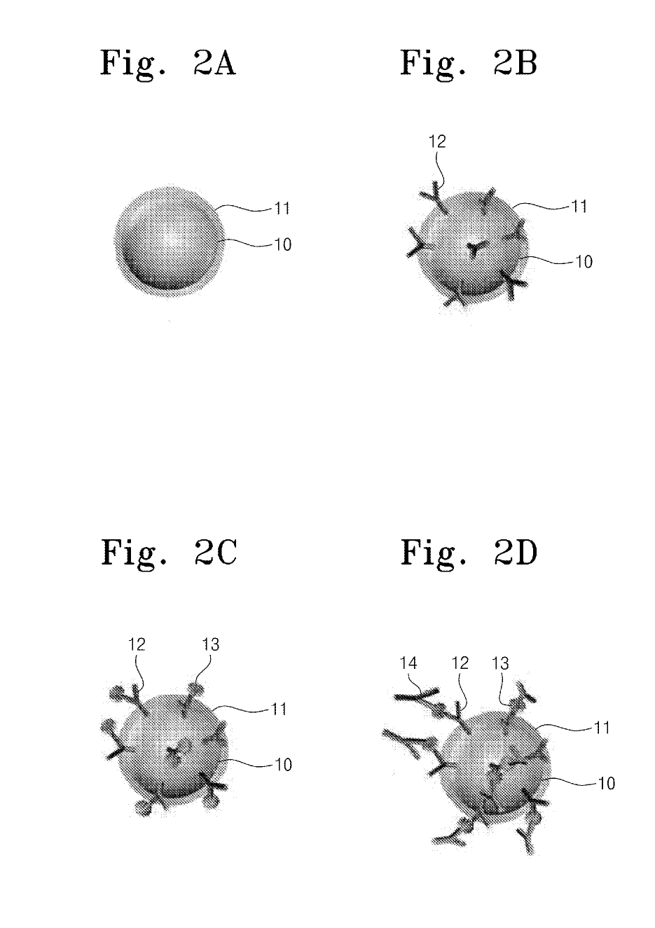

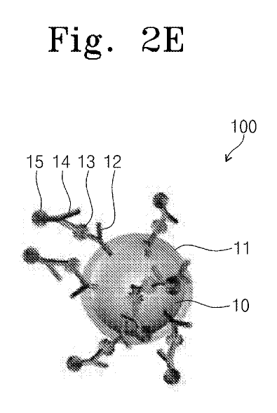

FIGS. 2A through 2E are drawings for describing a method of preparing a complex for diagnosing Alzheimer's disease.

According to embodiments, a magnetic particle 10-multiprotein complex 100 having beta-amyloid bonded to a surface of the magnetic particle 10 by an antigen-antibody reaction may be formed.

Referring to FIG. 2A, the magnetic particle 10 for diagnosing Alzheimer's disease is prepared. The magnetic particle 10 may be a fine particle having a diameter ranging from about 100 nm to about 5 μm. The magnetic particle 10 may include any one of iron (Fe), manganese (Mn), nickel (Ni), and cobalt (Co). For example, the magnetic particle 10 may be formed of Fe, ε-Co, Co, Ni, FePt, CoPt, γ-Fe₂O₃, Fe₃O₄, CoO, and CoFe₂O₄.

The surface of the magnetic particle 10 may be functionalized in order to uniformly adsorb a primary capture antibody 12 only selectively bonded with beta-amyloid. For example, a functional group 11, such as a carboxyl group (—COOH), a thiol group (—SH), a hydroxyl group (—OH), a silane group, an amine group, or an epoxy group, may be derived on the surface of the magnetic particle 10.

Referring to FIG. 2B, the primary capture antibodies 12 only selectively bonded with beta-amyloid, Alzheimer's disease-causing protein, are adsorbed on the surface of the magnetic particle 10.

The surface of the magnetic particle 10 is pretreated in order for the primary capture antibodies 12 to be adsorbed on the surface of the magnetic particle 10 in a constant distribution, before the primary capture antibodies 12 are adsorbed. The pretreatment of the surface of the magnetic particle 10 is performed by reacting using 1-ethyl-3-(3-dimethylaminopropyl)carbodiimide (EDC) or 1-cyclohexyl-3(2-morpholinoethyl)carbodiimide metho-p touluensulfonate (CMC).

The primary capture antibodies 12 are adsorbed on the pretreated surface of the magnetic particle 10 and then cultured at room temperature for about 2 hours. At this time, specificity of the primary capture antibodies 12 only selectively bonded with beta-amyloid protein is increased by using a monoclonal antibody.

After being cultured, a blocking material may be adsorbed on the surface of the magnetic particle 10 having no primary capture antibodies 12 bonded therewith in order to prevent nonspecific binding of other proteins. For example, goat-serum or 1% to 4% of bovine serum albumin (BSA) may be used as a blocking material, and the blocking material is adsorbed and then cultured at room temperature for about 2 hours.

Referring to FIG. 2C, saliva including beta-amyloid corresponding to an antigen is introduced to fix beta-amyloid to the magnetic particle 10.

Specifically, saliva including beta-amyloid is introduced into the magnetic particle 10 having the primary capture antibodies 12 adsorbed thereon and cultured at room temperature for about 3 hours. When the saliva including beta-amyloid is introduced, the primary capture antibodies 12 adsorbed on the magnetic particle 10 and the beta-amyloid may be specifically bonded.

Referring to FIG. 2D, detection antibodies 14 are bonded with beta-amyloid 13 bonded to the primary capture antibodies 12. Specifically, the detection antibodies 14 are reacted for about 2 hours so as to be bonded with other epitopes of the beta-amyloid 13 bonded to the primary capture antibodies 12. At this time, a binding ratio with beta-amyloid may be increased by using a polyclonal antibody as the detection antibody 14. An antibody generated in a host animal different from a host animal of the primary capture antibodies 12 may be used as the detection antibody 14. A type of the host animal of the detection antibody is selected so as to be the same type as that of a serum antigen of a secondary capture antibody 15 in the next operation.

Referring to FIG. 2E, the secondary capture antibodies 15 only bonded to the detection antibodies 14 bonded to the beta-amyloid 13 are bonded to form a magnetic particle-multiprotein complex 100.

The secondary capture antibodies 15 may be labeled with fluorescent substances to quantitatively identify the amount of the beta-amyloid 13 bonded to the magnetic particle 10. The secondary capture antibody 15 is only specifically bonded to the detection antibody 14 and is not specifically bonded to the primary capture antibody 12.

The secondary capture antibodies 15 may be labeled with the fluorescent substances before being provided to the magnetic particle 10 bonded with the beta-amyloid 13. The fluorescent substances may be a material emitting light having a wavelength band transmitting an optical filter layer of the photoelectric conversion device. For example, the fluorescent substances may be formed of a material emitting light having a wavelength band of 650 nm to 850 nm by an excitation beam having a wavelength ranging from 400 nm to 550 nm.

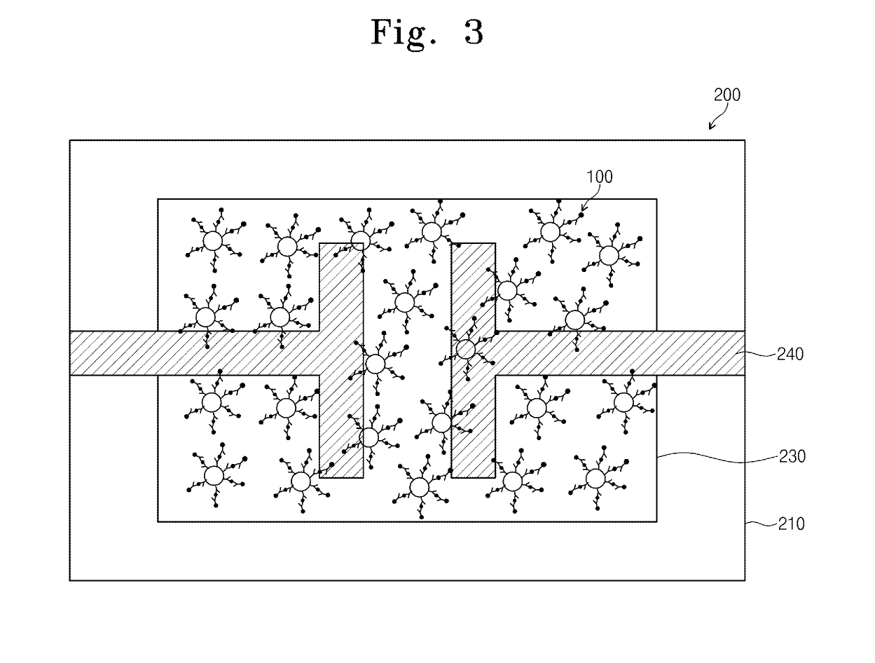

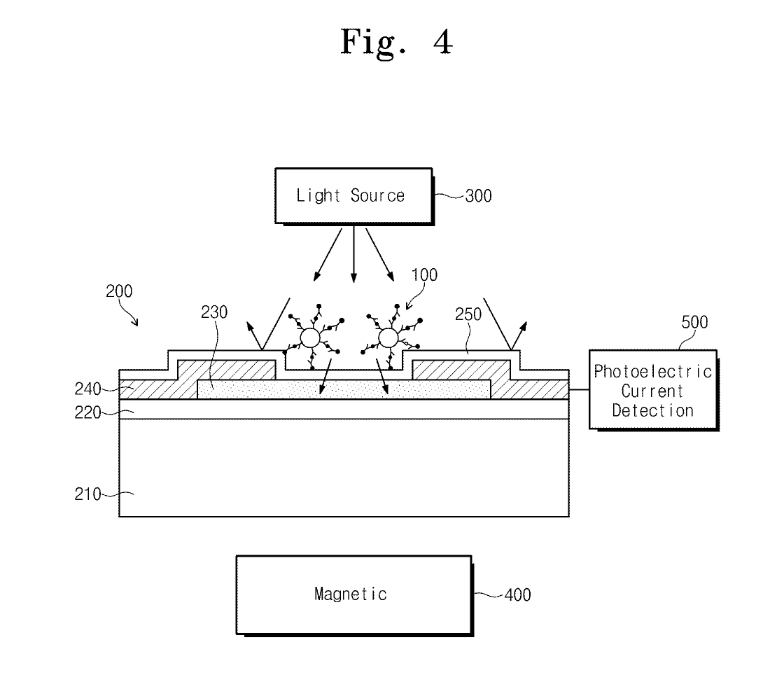

FIG. 3 illustrates a photoelectric conversion device for diagnosing Alzheimer's disease according to an embodiment of the present invention. FIG. 4 illustrates a biomaterial detection device for diagnosing Alzheimer's disease according to an embodiment of the present invention.

Referring to FIGS. 3 and 4, the biomaterial detection device includes a photoelectric conversion device 200, a light source 300, a magnetic field generating device 400, and a photoelectric current measuring device 500. The photoelectric conversion device 200 includes a semiconductor substrate 210, a channel pattern 230, interconnection electrodes 240, and an optical filter layer 250. The photoelectric conversion device 200 may have a back-gate structure.

Specifically, an insulation layer 220 is disposed on the semiconductor substrate 210 and the channel pattern 230 is disposed on the insulation layer 220. The insulation layer 220 may be a silicon oxide layer, a silicon oxynitride layer, or a silicon nitride layer. The channel pattern 230 may be formed by depositing and patterning a semiconductor material on the insulation layer 220. The channel pattern 230 may be formed of amorphous silicon.

The interconnection electrodes 240 may be disposed on the channel pattern 230 by being spaced from each other. The interconnection electrodes 240 may be formed by depositing and patterning a conductive layer on the channel pattern 230. The interconnection electrodes 240 may be electrically connected to the photoelectric current measuring device 500 of the biomaterial detection device and measure electrical changes in the channel pattern 230.

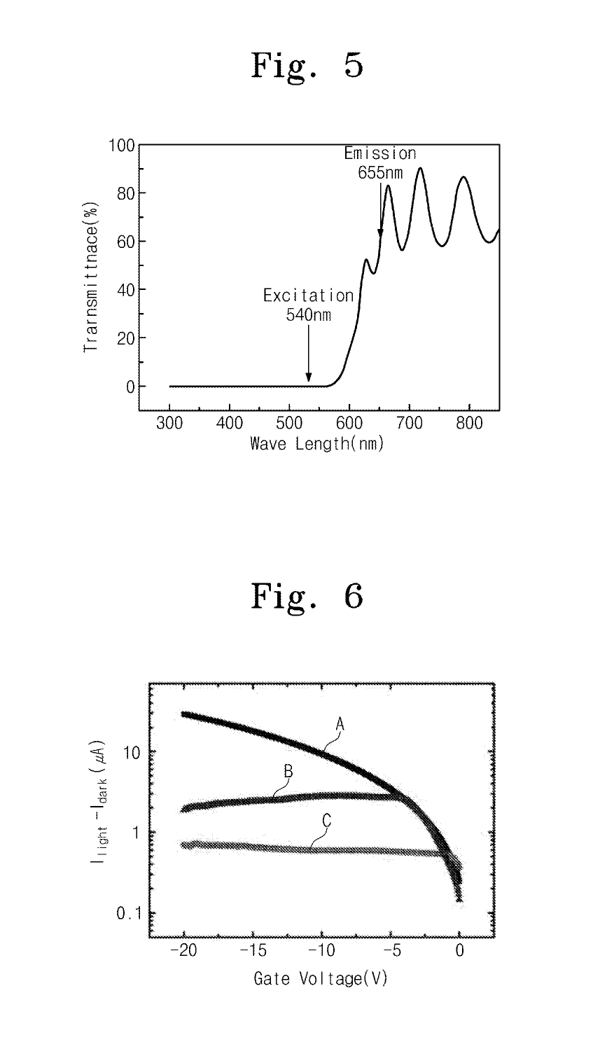

The optical filter layer 250 is disposed on the channel pattern 230 having the interconnection electrodes 240 formed thereon. An optical medium reflecting light having a specific wavelength band and transmitting light having a specific wavelength band may be used as the optical filter layer 250. According to an embodiment, the optical filter layer 250 may be formed of selenium (Se). As illustrated in FIGS. 2A and 2E, the secondary antibody may be determined according to optical transmission characteristics of the optical filter layer 250 during the formation of the complexes 100 for diagnosing Alzheimer's disease according to the embodiment of the present invention. The optical transmission characteristics of the optical filter layer 250 formed of selenium will be described with reference to FIGS. 5 and 6.

The magnetic particle-multiprotein complexes 100 may be disposed on the optical filter layer 250 between the interconnection electrodes 240. The complexes 100 may be fixed to the channel pattern 230 of the photoelectric conversion device 200 by the external magnetic field 400 provided under the semiconductor substrate 210. For example, a small magnet or a device generating a magnetic field may be disposed under the semiconductor substrate 210.

The complexes 100 are disposed on the optical filter layer 250 and the complexes 100 may be irradiated with light form the light source 300. Fluorescence may be excited from the fluorescent substances of the complexes 100 by incident light. At this time, the incident light provided from the light source 300 may be light having a specific wavelength band and the fluorescence emitted from the fluorescent substances by the incident light may transmit the optical filter layer 250.

According to an embodiment, light having a wavelength band of 650 nm to 850 nm may be emitted from the fluorescent substances of the magnetic particle 10-multiprotein complexes 100 by the excitation light having a wavelength ranging from 400 nm to 550 nm. The emission light emitted from the fluorescent substances may change photoelectric current flowing in the channel pattern 230 by transmitting the optical filter layer 250 of the optical field effect transistor.

FIG. 5 is a graph showing optical characteristic conditions in the photoelectric conversion device for diagnosing Alzheimer's disease according to the embodiment of the present invention.

FIG. 5 illustrates optical transmission characteristics of a selenium layer in the case that an optical filter layer of the photoelectric conversion device is formed of the selenium layer. Referring to FIG. 5, it may be understood that light having a wavelength band of 600 nm or less is not transmitted and light having a wavelength band of about 655 nm is only transmitted. Therefore, the wavelength band of an excitation light source may be set as 540 nm and the secondary antibody emitting at 655 nm may be used for diagnosing Alzheimer's disease according to the embodiment of the present invention.

FIG. 6 is a graph showing photoelectric current characteristics of the photoelectric conversion device for diagnosing Alzheimer's disease according to the embodiment of the present invention.

Graph A in FIG. 6 represents a magnitude of current generated by the photoelectric conversion device due to an excitation light source (excitation beam, 640 nm) in the case of no optical filter layer in the optical field effect transistor. Graph C in FIG. 6 represents a current generation rate obtained by filtering the excitation light source (i.e., light having a wavelength band of 600 nm or less) in the case that a selenium thin film is used as the optical filter layer. When Graph A and Graph C are compared, it may be confirmed that the current generation rate is lower in the case that the photoelectric conversion device includes the optical filter layer in comparison to the case of no optical filter layer. Graph B in FIG. 6 represents a current generation rate measured from the photoelectric conversion device in the case that magnetic particle-multiprotein complexes are disposed on the selenium thin film, an optical filter layer. Referring to Graph B, current is generated by emission light (655 nm) emitted from the fluorescent substances and it may be understood that the generated current is lower than the current generation rate of the case of no selenium thin film and is higher than the current generation rate of the case of having the selenium thin film.

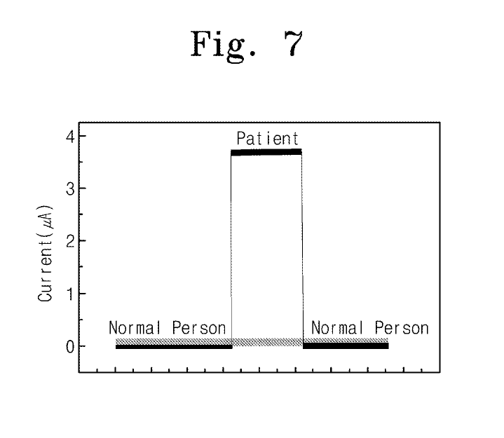

FIG. 7 is a graph showing photoelectric current characteristics according to a concentration of beta-amyloid contained in saliva in the method of diagnosing Alzheimer's disease according to the embodiment of the present invention.

Referring to FIG. 7, in the case that a trace amount of beta-amyloid is contained in saliva (i.e., normal person), since beta-amyloid is almost not bonded to the magnetic particles, an amount of light emitted from the complexes disposed on the photoelectric conversion device is low. As a result, since the light transmitting the optical filter layer is less, it may be confirmed that an amount of photoelectric current measured from the photoelectric conversion device is close to zero.

In contrast, in the case that a large amount of beta-amyloid is contained in saliva (i.e., Alzheimer's disease patient), since the amount of beta-amyloid bonded with the magnetic particles is high, the amount of light emitted from the complexes disposed on the photoelectric conversion device may be increased. As a result, since the amount of light transmitting the optical filter layer increases, it may be confirmed that the amount of photoelectric current measured from the photoelectric conversion device increases.

According to an embodiment of the present invention, detection of beta-amyloid protein may be possible in saliva of an Alzheimer's disease patient or a suspected Alzheimer's disease patient, not in biological samples such as skin tissue, rectal tissue, marrow, and spinal fluid.

Also, a magnetic-multiprotein complex reacting with easily sampled saliva is disposed on an photoelectric conversion device to measure photoelectric current caused by microscopic light, and thus, Alzheimer's disease may be diagnosed cheaper, safer, and simpler than a typical method. That is, Alzheimer's disease may be quantitatively and accurately identified according to an amount of beta-amyloid contained in saliva and thus, it may be possible to classify and diagnose as Alzheimer's disease patient or normal person.

Further, a degree of intensification of Alzheimer's disease is graded according to a degree of changes in photoelectric current and thus, early diagnosis or a state of intensification of Alzheimer's disease for an examinee may be quantified.

While the present invention has been particularly shown and described with reference to exemplary embodiments thereof, it will be understood by those of ordinary skill in the art that various changes in form and details may be made therein without departing from the spirit and scope of the present invention as defined by the following claims. Therefore, the preferred embodiments should be considered in descriptive sense only and not for purposes of limitation.

What is claimed is:

1. A method of diagnosing Alzheimer's disease, the method comprising:
preparing magnetic particles having primary capture antibodies specifically bonded with beta-amyloid adsorbed thereon;
introducing saliva containing beta-amyloid into the magnetic particles to bond the beta-amyloid contained in the saliva with the primary capture antibodies;
bonding secondary capture antibodies labeled with fluorescent substances to the magnetic particles bonded with the beta-amyloid to form a complex;
disposing the complex in a channel region of an photoelectric conversion device in which photoelectric current is changed according to an amount of incident light; and
measuring photoelectric current changed by light excited from the complex to quantify a concentration of the beta-amyloid contained in the saliva.

2. The method of claim 1, wherein the photoelectric conversion device comprises an optical filter layer only transmitting a wavelength of excitation light excited from the fluorescent substances.

3. The method of claim 2, wherein the optical filter layer is a Se (selenium) thin film.

4. The method of claim 2, wherein the photoelectric conversion device comprises a semiconductor substrate, an insulation layer on the semiconductor substrate, a channel pattern on the insulation layer, and .interconnection electrodes disposed on the channel pattern by being spaced apart from each other.

5. The method of claim 4, wherein the optical filter layer is disposed on the channel pattern.

6. The method of claim 1, wherein the fluorescent substances are formed of a material emitting light having a wavelength band of 650 nm to 850 nm by excitation light having a wavelength ranging from 400 nm to 550 nm.

7. The method of claim 1, wherein the magnetic particles comprise at least one selected from the group consisting of Fe (iron), Mn (manganese), Ni (nickel), and Co (cobalt).

8. The method of claim 1, wherein a diameter of the magnetic particles is in a range of 100 nm to 5 μm.

9. The method of claim 1, wherein the primary capture antibodies are bonded to the magnetic particles by a chemical reaction with EDC (1-ethyl-3-[3-dimethylaminopropyl]carbodiimide hydrochloride) or CMC (1-cyclohexyl-3(2-morpholinoethyl)carbodiimide metho-p touluensulfonate).

10. The method of claim 1, wherein the primary capture antibody is a monoclonal antibody and the secondary capture antibody is polyclonal antibody.

11. The method of claim 1, further comprising bonding blocking molecules on surfaces of the magnetic particles not bonded with the primary capture antibodies.

12. The method of claim 1, wherein the disposing of the complex in the channel region of the photoelectric conversion device is fixing the complex to the channel region by using an external magnetic field.

13. The method of claim 1, wherein the primary capture antibody is adsorbed by a carboxyl group (—COOH), a thiol group (—SH), a hydroxyl group (—OH), a silane group, an amine group (—NH₂), or an epoxy group, derived on the surfaces of the magnetic particles.

14. A method of diagnosing Alzheimer's disease, the method comprising:
preparing comparison samples having different concentrations of beta-amyloid;
preparing magnetic particle samples having beta-amyloid contained in the each comparison sample combined with multiprotein;
measuring changes in photoelectric current from the magnetic particle samples by using an optical field effect transistor, in which photoelectric current is changed according to an amount of light, to generate reference data;
introducing saliva containing beta-amyloid to prepare magnetic particles having the beta-amyloid contained in the saliva bonded with the multiprotein;
measuring changes in photoelectric current from the magnetic particles by using the photoelectric conversion device to generate measurement data; and
comparing the reference data and the measurement data to diagnose the presence of Alzheimer's disease.

15. The method of claim 14, wherein the concentration of beta-amyloid in the comparison samples is in a range of 1 pg/ml to 5,000 pg/ml.
